(19) United States
(12) Patent Application Publication
(10) Pub. No.: US 2018/0369942 A1
(43) Pub. Date: Dec. 27, 2018

(54) TIRE RASP BLADE

(71) Applicant: ELGI RUBBER COMPANY LTD., TAMILNADU (IN)

(72) Inventor: Charles K. STANFIELD, TAMILNADU (IN)

(73) Assignee: ELGI RUBBER COMPANY LTD., TAMILNADU (IN)

(21) Appl. No.: 16/066,257

(22) PCT Filed: Dec. 30, 2016
(86) PCT No.: PCT/IB2016/058101

§ 371 Date: Jun. 26, 2018

(30) Foreign Application Priority Data
Dec. 30, 2015 (IN) 7083/CHE/2015

(51) Int. Cl. B23D 71/02; B29D 30/54

(52) U.S. Cl. CPC B23D 71/025; B29D 2030/541; B29D 30/54

(57) ABSTRACT

A tire rasp blade for a buffing machine including least three arc segments of buffing leading edges with coarse and fine pitches with variable segment angles are arranged in between the terminal ends, to form arcuate working end with a working end angle. The first arc segment is defined by a coarse pitch and is arranged at one terminal end followed by an arrangement of second and third arc segments that are defined by an incremental fine pitch.

### FIELD OF THE INVENTION

The present invention provides a tire rasp blade with a working end for use in tire buffing machines to precondition tires for retreading. The present invention particularly provides a tire rasp blade having a working end of buffing leading edges that are segmented with coarse and fine pitches, to enhance the rate of removal of tread from a tire, while rendering the tire with a fine surface texture.

### BACKGROUND OF THE INVENTION

In tire retreading processes, used tires require preparation prior to retreading of these tires. In this process, the outer area of a used tire is buffed to remove the old surface and to provide a surface with a uniform texture, which is suitable for adhesion of a new tread.

Buffing is a process by which a used tire is rotated and contacted with a rapidly rotating cylindrical hub containing toothed cutters (rasp blades), which are spaced apart from one another. The positioning of the rasp blades within the hub is varied to suit the requirement of a range of different buffing machines.

Generally, the factors that contribute to the performance of a rasp blade include, generated temperature, energy consumption, texture, and longevity.

It is also known in the art that rasp blades of fine pitch (more teeth), provide a finer texture. However, the rate of removal of treads during buffing operation, is lower in rasp blades with fine pitch as compared to rasp blades with a greater pitch.

Therefore, rasp blades with a greater pitch provide an increased rate of removal of tread along with low temperature and good longevity. However, in the performance of this process, it also observed that the texture of the surface of the tread of the tire is more coarse and energy consumption is higher.

As it is customary in the tire rasp blade art that the teeth of the blades and working end are displaced either angular or laterally from the plane of the blade's body portion so that the trailing edge of any one tooth is positioned on the opposite side of the blade from that of the leading edge of the next following adjacent tooth.

Rasp blades that are commonly used in buffing machines for buffing used vehicle tires, come with various configurations of working end having 16, 20, 25 etc. The number of arrangement of teeth to the form the working end determines the fine or coarse pitch of rasp blades.

For instance, rasp blades with working ends having 16 teeth (coarse pitch)are used to prefer an enhanced rate of removal of the tread from used tires. However, the buffing of used tire treads with such rasp blades, affects the surface texture of the tire, resulting in adhesion issues at the time of affixing of new tread. Rasp blades with such coarse pitches are also prone to breakage during buffing operations.

Whereas, rasp blades with 25 teeth (fine pitch) are used in buffing operations of used tires to obtain fine surface texture for affixing the tire tread. In such buffing operations, a fine surface texture is obtained and in the process the rate of removal of used tread gets reduced.

Therefore, a rasp blades with different sets of pitch arrangements of teeth are used for different applications. For instance, rasp blades with working ends(teeth with coarse pitch) are generally preferred for buffing the off-the-road (OTR) tires and whereas the rasp blades with working ends(teeth with fine pitch) are used for the tires of trucks and passenger vehicles.

US 2004/0234347 discloses a rasp blade arrangement where the teeth are alternately arranged with fine and coarse pitches. In this arrangement projections of the rasp blades are used as spacers and the rasp blades are arranged offset to each other to provide a better abrading surface.

Therefore, there is a need to provide a rasp blade with a suitable working end, which is configured to be used across a wide range of tires, where not only the rate of removal of used tread is maintained at a desired level during the course of buffing operation but also a buffed tire with a fine surface texture is obtained.

### SUMMARY OF THE PRESENT INVENTION

The embodiments of the tire rasp blade of a buffing machine assembly are directed to a tire rasp blade for a buffing machine including a planar body with terminal ends. At least three arc segments of buffing leading edges with coarse and fine pitches with variable segment angles are arranged in between the terminal ends, to form an arcuate working end with a working end angle. The first arc segment is defined by a coarse pitch and is arranged at one terminal end followed by an arrangement of second and third arc segments that are defined by an incremental fine pitch.

In an aspect, tire rasp blade with a working end of buffing leading edges formed by an interplay of fine and coarse pitches is provided where the tooth profiles are oriented at relative variable angles, to enhance the rate of removal of tread from tires, while providing a surface with fine texture for subsequent retreading.

In another aspect, a tire rasp blade with an working end with segments of buffing leading edges with fine pitch and coarse profiles is provided, where these segments are arranged in between the terminal ends of the tire rasp blade with an emphasis on an incremental increase in fine pitch segments.

In yet another aspect, a tire rasp blade with buffing leading edges having coarse and pitch profiles is provided where the profiles are oriented at respective variable angles.

In further aspect, a tire rasp blade with buffing teeth profiles of fine and coarse pitches is provided where these profiles are arranged alternately between the terminal ends of the tire rasp blade.

In another aspect, a tire rasp blade with at least two arc segments of buffing leading edges with coarse and fine pitches with variable segment angles are arranged in between the terminal ends.

In yet another aspect, the first, second and third arc segments are disposed with a variable radii.

### BRIEF DESCRIPTION OF THE DRAWINGS

The novel features of the present invention are set forth in the appended claims. However, the preferred embodiments together with objects and advantages are best understood by reference to the following description taken in connection with the accompanying drawings in which:

FIG. 1(a) illustrates a plan and side elevational view of tire rasp blade with a working end of three segments made in accordance with one embodiment of the present invention.

FIG. 1(b) is a detail partial view of a first arc segment of working end of the rasp blade as illustrated in FIG. 1(a).

FIG. 1(c) is a detail partial view of a second arc segment of working end of the rasp blade as illustrated in FIG. 1(a).

FIG. 1(d) is a detail partial view of a third arc segment of working end of the rasp blade as illustrated in FIG. 1(a).

FIG. 2 is a side elevational view illustrating a tire rasp blade with alternate pitch arrangement of working end in accordance with another embodiment of the present invention.

FIG. 3 is a side elevational view illustrating tire rasp blades with segments of working end arranged co-axial to each other.

FIG. 4 is a side elevational view illustrating a 9″ diameter rasp blade with three segments of varying leading edge pitch, pitch angle and leading edge angle.

FIG. 5 illustrates a plan and side elevational view of tire rasp blade with a working end of two segments made in accordance with one embodiment of the present invention.

### DETAILED DESCRIPTION OF THE EMBODIMENTS

Tire rasp blades are generally mounted radially along the circumference of a rotatable rasp hub of a buffing machine, in the direction of hub rotation (clockwise and counter clockwise directions), so that the rasp blades render an oscillating, side-to-side action as the hub rotates during the buffing of tires, which is known in the art.

The preferred embodiments of the tire rasp blade of the present invention are now described by referring to the exemplary drawings.

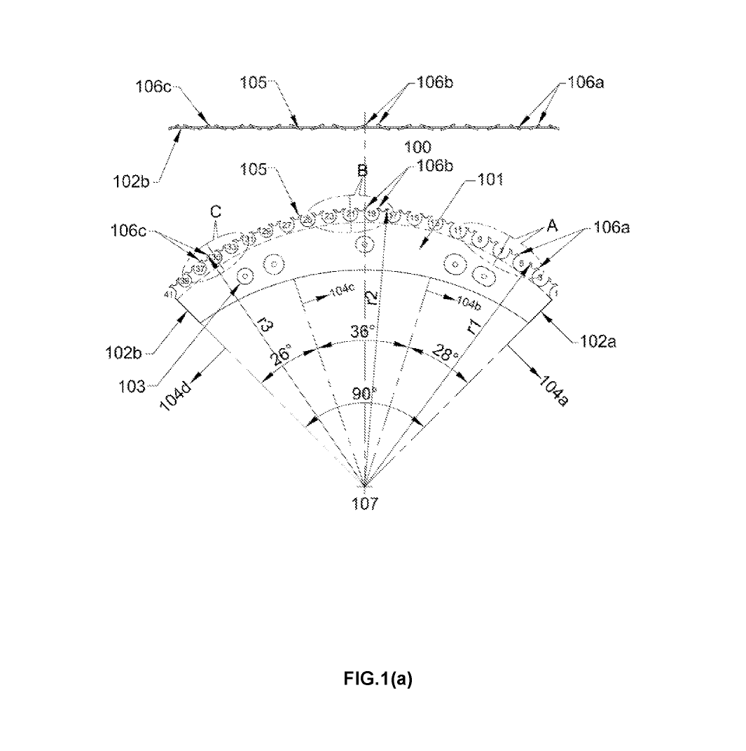

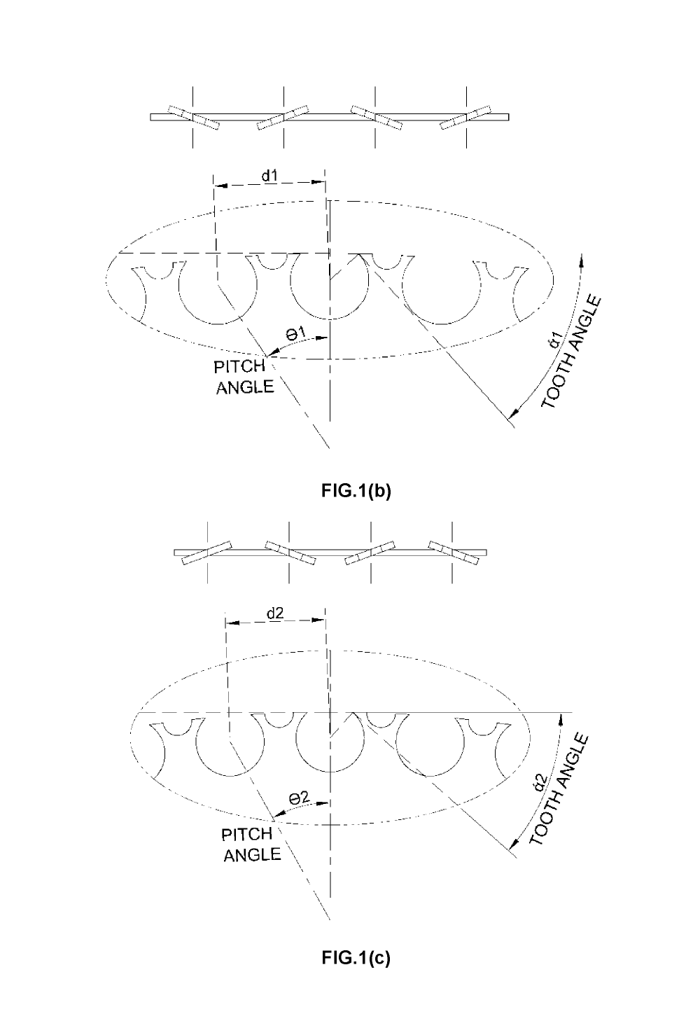

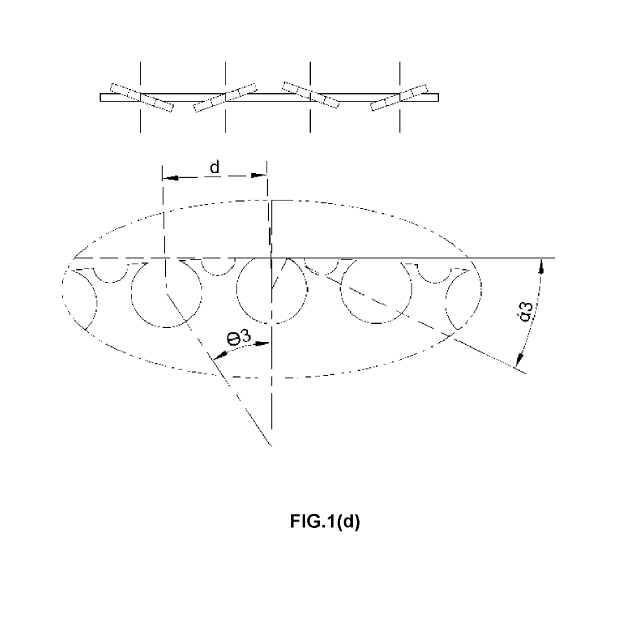

The tire rasp blade, generally designated as 100 of the present invention, is as illustratively shown in FIG. 1(a). The rasp blade in accordance with the present invention is stamped or otherwise formed of sheet metal to a generally concavo-convex shape as illustrated in FIG. 1(a).

A plurality of such tire rasp blades can be arranged about the axis of a selected hub assembly, in which the rasp blades are to be incorporated to rotate and abrade the surface of a tire in a desired manner. In this exemplary aspect, the rasp blade 100 is shown for use in a hub with a diameter of 9″ (inches). It is well within the purview of this invention to here that rasp blades of the present invention can be suitably adapted for use in the hub assemblies with other suitable diameters such as 10.5″ and 11.5″.

A body 101of the rasp blade 100 is generally planar with terminal ends namely, the right terminal end 102a and the left terminal end 102b, as shown in FIG. 1(a). The body 101 defines a plane that is perpendicular to the axis of rotation of the body 101. The rasp blade 100 is adapted for fitment to the desired hub assembly, through mounting holes 103, along with pins and spacers running between end plates of the hub assembly, as is known in the art. The body 101 of the rasp blade 100 is arranged between the terminal ends 102a and 102b. Base lines 104a and 103e extending from a common point 107 (vertex) to the terminal ends 102a and 102b, define an angular extent between the terminal ends 102a and 102b of the body 101 of the rasp blade 100. In this exemplary aspect, the angular extent that is formed between the base lines 104a and 104d of the tire rasp blade 100 is about 90°, which is not a limiting factor. As a result, a total number four rasp blades 100 are arranged end-to-end in the hub assembly, to form a full circle or angle of 360°. It will be appreciated here that the angular extent can be suitably varied from 60° to 90°, depending on the end use of the rasp blades. The tire rasp blades of 9″ diameter generally include 4 blades per 360° (90°×4 blades). Whereas, tire rasp blades of 10.5″ diameter generally include 5 tire rasp blades per 360° deg (72°×5 blades). Similarly, the tire rasp blades of 11.5″ diameter are either with 5 rasp blades per 360° (72°×5 blades) or 6 blades per 360° (60°×6 blades).

The rasp blade 100, which is arranged in the hub assembly, is configured to rotate both in clockwise and counter clockwise directions. Accordingly, a desired terminal end 102a or 102b of the rasp blade 100 is permitted, alternately, to contact the tire surface, during the course of operations.

A working end 105 of the body 101 is formed to extend peripherally from the terminal ends 102a and 102b with an arcuate configuration. The working end 105 is defined by a plurality of cutouts or openings which are smaller and larger in diameters thereby forming corresponding buffing leading edges 106a, 106b and 106c. The buffing leading buffing edges with smaller diameter larger diameter are arranged alternately along the working end 105 and the leading buffing edges the working end are twisted away from the surface of the planar body 101, as shown in FIG. 1(a).

In an exemplary aspect as shown in FIG. 1(a), which is the working end of a 9″ diameter rasp blade, the cutouts with larger and smaller diameters are designated as 1-41 from the terminal end 102a to the terminal end 102b. Among the cutouts 1-41, the odd-numbered cutouts are designated as 1, 3, 5, 7, 9, 11, 13, 15, 17, 19, 21, 23, 25, 27, 29, 31, 33, 35, 37, 39 and provided with larger diameters and whereas the even-numbered cutouts are designated as 2, 4, 6, 8, 10, 12, 14, 16, 18, 20, 22, 24, 26, 28, 30, 32, 34, 36, 38 are provided with smaller diameter. The combination of cutouts with smaller and larger diameters, defines the two individual leading cutting/buffing edges 106a, 106b and 106c in a dove-tail configuration. The working end 105 of each of the tire rasp blade 100 protrudes away from the hub assembly, while it is arranged in the hub for cutting/buffing operations. Accordingly, depending on the direction of the rotation of the hub assembly (clockwise and anticlockwise), one of the leading cutting/buffing edges comes into contact with the surface of the tire. The cutouts as shown in FIG. 1(a) are exemplarily shown with a semi-circular configuration. It is within the purview of this invention to use other non-circular shapes such as triangular, square and other suitable shapes. The working end angle of the arcuate working end 105 is in the range of 60-90 degrees.

The working end 105, which is arranged between the terminal ends 102a and 102b of the of the body 101, is segmented into at least first, second and third arc segments. It is understood here that number three arc segments are shown to illustratively describe the preferred embodiments of tire rasp blade of the present invention. It is however, understood here that the total number of arc segments can be suitably varied considering the various end user requirements such as buffing of off-the-road tires, truck tires and passenger vehicle tires, in order to balance the requirements of rate of removal of carcass from the used tires and the formation of surface texture for consequential retreading.

Now, by specifically referring to FIG. 1(b), in addition to FIG. 1(a), the constructional features of the first arc segment of the working end 105 are described. The first arc segment is arranged to extend from the terminal end 102a, where the first arc segment is defined by the cutouts or openings 1-11 having larger and smaller diameters to form the leading edges 106a. The cutouts 1-11 are arranged adjacent to each other to form a coarse pitch (d1). The term adjacent as used in the context of the present invention is intended to mean that the trailing edge of one buffing leading edge and the leading edge of the following buffing leading edge are spaced in a variable pitch combination. It is understood that this combination of variable pitch may apply as well to groups of buffing leading edges in a variety of combinations.

In an embodiment as shown in FIG. 1(a) and FIG. 1(b), the coarse pitch (d1) of the buffing leading edges 106a of the first arc segment for the rasp blade with an exemplary diameter of 9″, is advantageously in the range of 8-11 mm, preferably about 9.75 mm. The course pitch (d1) is the distance between the centre points of the cutouts with larger diameters.

The pitch in this context refers to the separation between a feature of a cutout formation and the equivalent feature of the next adjacent cutout formation along the arcuate working end of the tyre rasp blade. The pitch (d1) as shown here for an exemplary rasp blade of 9″ diameter, which is not a limiting factor. In other words, the buffing leading edges in the first arc segment are arranged in a substantially distant configuration so as to render a coarse pitch to the buffing leading edge of this segment. Whenever, this first arc segment comes into contact with the tire during the course of buffing operations, the removal rate of the carcass of the tire is increased.

A radius (r1) as shown in FIG. 1(a), is formed between the centre point 107 and the working end (buffing leading edges of the first arc segment) and this radius (r1) is substantially constant across the first arc segment, commencing from the terminal end 102a of the body 101.

Considering the exemplary angle of extent of the rasp blade ad 90°, the first arc segment is defined with an angle in the range of 10-35°, preferably 20-30° and most preferably 28°. The first arc segment with such preferred segment angles having a coarse pitch facilitate the enhanced removal of carcass from the tire, prior to the texturing of the surface.

A buffing leading edge angle (θ1) in the range of 45-55°, preferably about 47° is formed between top portion of the buffing leading edge and bottom portion of the bottom edge of the cutout of the larger diameter, as exemplarily shown in FIG. 1(b). This buffing leading edge angle is used to provide the correct balance for sharpness and strength of the leading edges. The greater the buffing leading edge angle the less the ability to shear the rubber surface of the tire. Whereas, a lesser angle and the acute tooth tip becomes too fragile. These factors are required to be reckoned for defining the opening between the leading and trailing dimensions of buffing leading edges.

Now, by specifically referring to FIG. 1(c) in addition to FIG. 1(a), the features of the second arc segment of the working end 105 are described. The second arc segment is arranged to follow the first arc segment, which is formed from the cutouts 12-28 having the cutouts with smaller and bigger diameters and with resultant buffing leading edges 106b. The cutouts 12-28 are arranged adjacent to each other with a desired fine pitch (d2), advantageously in the range of 7-10 mm, preferably about 8.79 mm.

In other words, the leading edges in second arc segment are arranged in a closer configuration as compared to the preceding first arc segment, so as to render a fine pitch to the buffing leading edges of this segment. Accordingly, whenever this second arc segment comes into contact with the tire during the course of buffing operations, the removal rate of the carcass of the tire is substantially reduced and the corresponding enhancement of fine surface texture is facilitated. The second arc segment is arranged to an angle in the range of 20-40, preferably 30-40 degrees and most preferably at about 36° as measured from the indicative base lines 104b to the base line 104c. This angular arrangement of the second arc segment with a fine pitch arrangement facilitates the texturing of the surface tyre, which is subjected to the coarse operations.

A buffing leading edge angle (θ2) in the range of 40-50°, preferably about 45° is formed between top portion of the buffing leading edge and bottom edge of the cutout of the larger diameter, as exemplarily shown in FIG. 1(c).

A radius (r2) is formed between the centre point 107 and the working end (leading edges) of the second arc segment as shown in FIG. 1(a) and this radius (r2) is constant across the second arc segment.

Now, by specifically referring to FIG. 1(d) in addition to FIG. 1(a), the features of the third arc segment of the working end 105 are described. The third arc segment contiguous to the second and the first arc segments, which is formed from cutouts 29-41 with smaller and bigger diameters and leading edges 106c.

The cutouts 29-41 are arranged adjacent to each other with a pitch (d3), which is provided with a finer pitch as compared to the preceding second arc segment as exemplarily shown in FIG. 1(d). The pitch (d3) is advantageously in the range of 6-9 mm, preferably about 7.83 mm. The leading edges in third arc segment are arranged in a substantially closer configuration so as to render the desired pitch to the teeth of this segment. Whenever, this third arc segment comes into contact with the tire during the course of buffing operations, it only performs that fine texturing of the removed surface of the tire. The segment angle of the third arc segment is in the range of 10-35 degrees, preferably 20-30 degrees and most preferably about 26° as measured from the indicative base line 104c to base line 104d.

A buffing leading edge angle (θ3) in the range of 35-45°, preferably of about 42° is formed between top portion of the leading edge and the bottom edge of the cutout of the larger diameter, as exemplarily shown in FIG. 1(d).

A radius (r3) is formed between the centre point 107 and the working end (leading edges) of the third arc segment as shown in FIG. 1(a) and this radius (r3) is constant across the third arc segment.

In an aspect of the present invention, the radius r3 of the rasp blade 100 is greater than the radius r2 and r1 and the radius r2 is greater than r1. The variable radii of the first, second and third arc segments is the range of 0.25 to 0.50 mm. Therefore, in the tire rasp blade of the present invention the first, second and third arc segments are disposed with a variable radii. The adoption of arc segments of different radii, facilitates a progressive texturing of the surface of the tire and rate of removal is controlled, while the rasp blade is rotated either in clockwise or counter clockwise directions. In other words, the cutting radius cutting radius of the more closely spaced buffing leading edges is larger than the cutting radius of the buffing leading edges with coarse pitch, so that the buffing leading edges with a finer pitch will be the last to contact the surface of the surface to provide an enhanced surface texture.

Accordingly, the present invention provides a tire rasp blade for a buffing machine including a planar body 101 with terminal ends 102a and 102b. The planar body 101 is defined by at least three arc segments of buffing leading edges 106a, 106b and 106c having coarse and fine pitches. The arc segments are defined by variable segment angles, to form an arcuate working end with a working end angles. The first arc segment is defined by a coarse pitch and is arranged at one terminal end 102a followed by an arrangement of second and third arc segments that are defined by an incremental fine pitch.

In yet another aspect of the present invention the first, second and third arc segments are disposed with a pitch angle in the range of 2-7°.

In further aspect of the present invention the pitch and the buffing leading edge angles are maintained as constant within the respective arc segments. The sum of the buffing leading edge angles of the arc segments is equal to the working end angle.

It is however understood that this ratio of segment angles of the first, second and third arc segments can be suitably varied whenever there is a change in the number of segments or with same number of indicate segments (3). For instance, a combination of coarse, fine, finer and finest segments can also be formed in the 1:1.3:0.5:0.5. This ratio can be suitably modified for rasp blades with 10.5 and 11.5″. This ratio can also be varied for rasp blades of 10.5 and 11.5″.

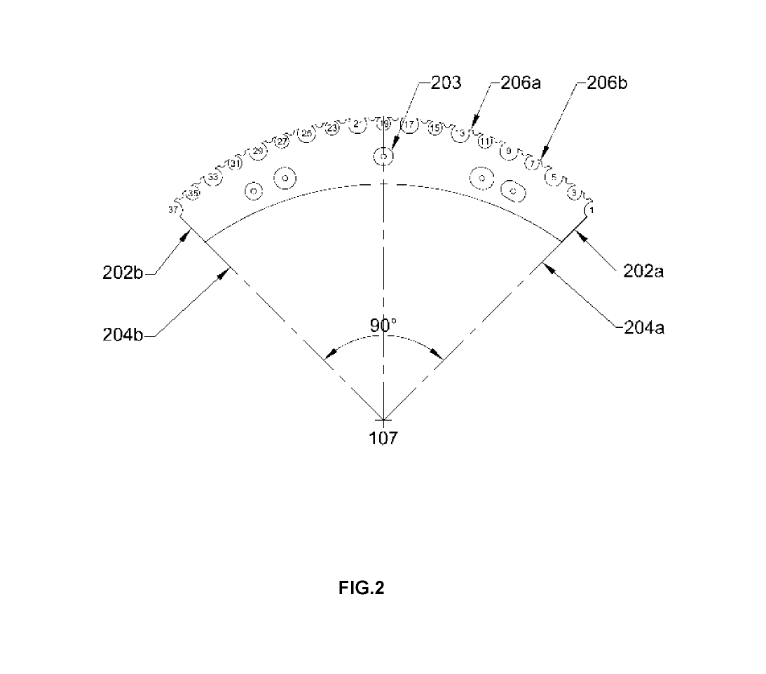

In an exemplary aspect as shown in FIG. 2, which is the working end of a 9″ diameter rasp blade, the cutouts with larger and smaller diameters are designated as 1-41 from the terminal end 102a to the terminal end 102b. Among the cutouts 1-41, the odd-numbered cutouts are designated as 1, 3, 5, 7, 9, 11, 13, 15, 17, 19, 21, 23, 25, 27, 29, 31, 33, 35, 37, 39 and provided with larger diameters and whereas the even-numbered cutouts are designated as 2, 4, 6, 8, 10, 12, 14, 16, 18, 20, 22, 24, 26, 28, 30, 32, 34, 36, 38 are provided with smaller diameter. The combination of cutouts with smaller and larger diameters, defines the two individual leading cutting/buffing edges 106a, 106b and 106c in a dove-tail configuration. The rasp blade 200 with buffing leading edges having fine and coarse pitches, formed by the cutouts 1-41 of larger and smaller diameter, which are arranged alternately between the terminal ends 202a and 202b of the body of the rasp blade 200 facilitates the removal of carcass from the used tire and texturing of the surface of the tire.

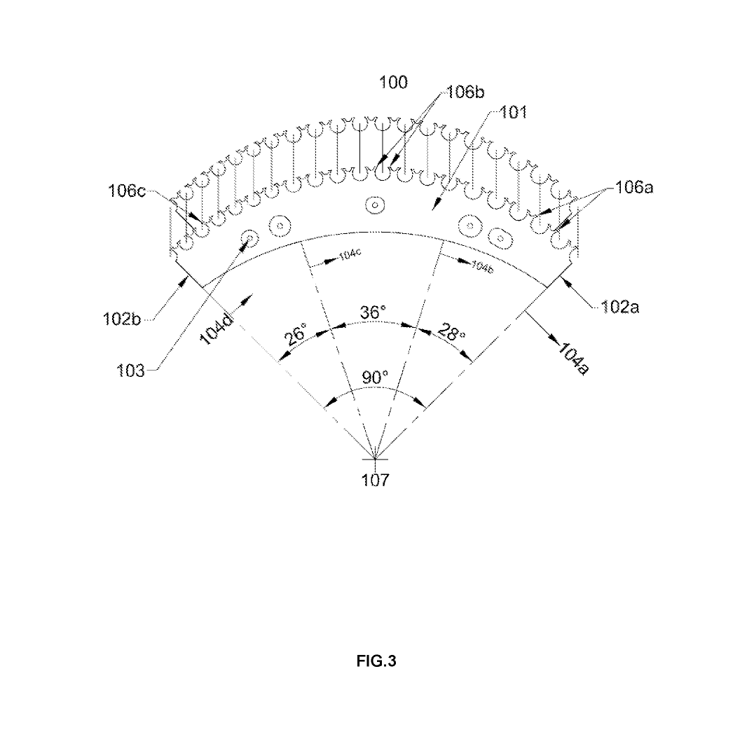

As shown in FIG. 3, which is an exemplary arrangement of the rasp blades in a hub, which are separated by spacers (not shown in the drawing), to provide an intervening distance between the rasp blades. In this arrangement the rasp blades are arranged co-axial to each other in the hub, so that the buffing leading edges of larger and smaller diameters are co-axial, during the buffing operations. The coaxial arrangement of the tire rasp blades enhances the rate of rubber removal and provides a better buffing texture.

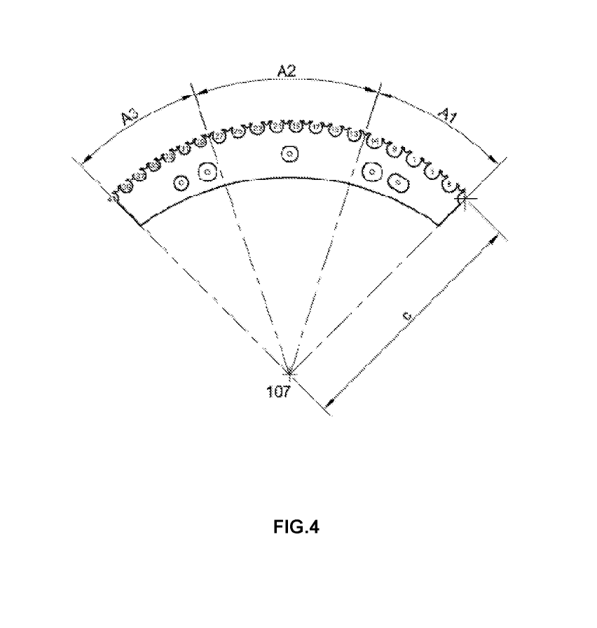

The typical dimensions for the tire rasp blade of 9″ diameter as shown in FIG. 1(a) and FIG. 4 are shown in Table 1.

TABLE 1

| CUTOUT | CUTOUT | SEGMENTANGLE | | | PITCH CIRCLE |
|---|---|---|---|---|---|
| No. | DIAMETER | A1 | A2 | A3 | RADIUS ‘c’ |
| 1 | 6.84 | 0° | — | — | 111.73 |
| 2 | 2.52 | 3° | — | — | 114.05 |
| 3 | 6.84 | 5° | — | — | 111.73 |
| 4 | 2.52 | 8° | — | — | 114.05 |
| 5 | 6.84 | 10° | — | — | 111.73 |
| 6 | 2.52 | 13° | — | — | 114.05 |
| 7 | 6.84 | 15° | — | — | 111.73 |
| 8 | 2.52 | 18° | — | — | 114.05 |
| 9 | 6.84 | 20° | — | — | 111.73 |
| 10 | 2.52 | 23° | — | — | 114.05 |
| 11 | 6.84 | 25° | — | — | 111.73 |
| 12 | 2.52 | 28° | 0° | | 114.05 |
| 13 | 6.00 | — | 2° | — | 111.91 |
| 14 | 2.52 | — | 5° | — | 114.17 |
| 15 | 6.00 | — | 7° | — | 111.91 |
| 16 | 2.62 | — | 9° | — | 114.17 |
| 17 | 6.00 | — | 11° | — | 111.91 |
| 18 | 2.52 | — | 14° | — | 114.17 |
| 19 | 6.00 | — | 16° | — | 111.91 |
| 20 | 2.52 | — | 18° | — | 114.17 |
| 21 | 6.00 | — | 20° | — | 111.91 |
| 22 | 2.52 | — | 23° | — | 114.17 |
| 23 | 6.00 | — | 25° | — | 111.91 |
| 24 | 2.52 | — | 27° | — | 114.17 |
| 25 | 6.00 | — | 29° | — | 111.91 |
| 26 | 2.52 | — | 32° | — | 114.17 |
| 27 | 6.00 | — | 34° | — | 111.91 |
| 28 | 2.52 | — | 36° | 0° | 114.17 |
| 29 | 5.28 | — | — | 2° | 112.23 |
| 30 | 2.52 | — | — | 4° | 114.30 |
| 31 | 5.28 | — | — | 6° | 112.23 |
| 32 | 2.52 | — | — | 8° | 114.30 |
| 33 | 5.28 | — | — | 10° | 112.23 |
| 34 | 2.52 | — | — | 12° | 114.30 |
| 35 | 5.28 | — | — | 14° | 112.23 |
| 36 | 2.52 | — | — | 16° | 114.30 |
| 37 | 5.28 | — | — | 18° | 112.23 |
| 38 | 2.52 | — | — | 20° | 114.30 |
| 39 | 5.28 | — | — | 22° | 112.23 |
| 40 | 2.52 | — | — | 24° | 114.30 |
| 41 | 5.28 | — | — | 26° | 112.23 |

It is therefore, evident from the Table 1, that the cutout diameter remains constant for the buffing leading edge in the respective segments resulting in a uniform pitch in that particular segment. The buffing leading edges of the first arc segment is in the range of 0-28°, for the second arc segment in the range of 0-36° degrees and for the third arc segment the buffing leading edges are in the range of 0-26°. The pitch circle radius as observed from the Table 1, indicates that the buffing leading edges of the rasp blade segments vary according to rasp blade segments. The buffing leading edge of the second arc segment has radius greater than the first arc segment and the radius of the third arc segment leading edge is greater than the second arc segment. This combination of segments render not only an enhanced rate of removal of the carcass of the tire surface but also provide a fine surface texture. The dimensions as indicated in Table 1 are intended to be illustrative only and not limiting on the scope of the invention.

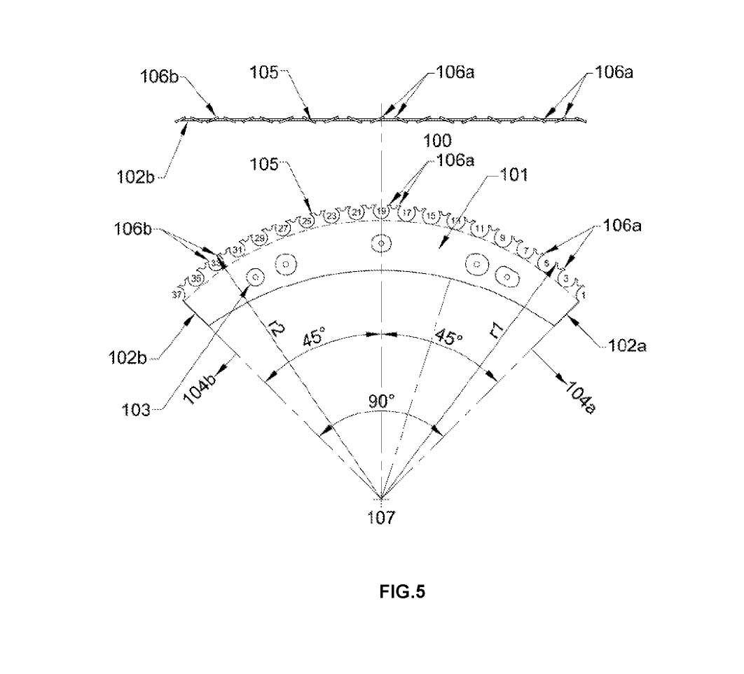

In yet another aspect of the present invention, the tire rasp blade with at least two arc segments of buffing leading edges with coarse and fine pitch, having variable radii and segment angles are arranged in between the terminal ends, as shown in FIG. 5.

A working end 105 of the body 101 is formed to extend peripherally from the terminal ends 102a and 102b with an arcuate configuration. The working end 105 is defined by a plurality of cutouts or openings which are smaller and larger in diameters thereby forming corresponding buffing leading edges 106a and 106b. The buffing leading buffing edges with smaller diameter larger diameter are arranged alternately along the working end 105 and the leading buffing edges the working end are twisted away from the surface of the planar body 101, as shown in FIG. 5.

In an exemplary aspect as shown in FIG. 5, which is the working end of a 9″ diameter rasp blade, the cutouts with larger and smaller diameters are designated as 1-37 from the terminal end 102a to the terminal end 102b. Among the cutouts 1-37, the odd-numbered cutouts are designated as 1, 3, 5, 7, 9, 11, 13, 15, 17, 19, 21, 23, 25, 27, 29, 31, 33, 35 and 37and provided with larger diameters and whereas the even-numbered cutouts are designated as 2, 4, 6, 8, 10, 12, 14, 16, 18, 20, 22, 24, 26, 28, 30, 32, 34 and 36 are provided with smaller diameter. The combination of cutouts with smaller and larger diameters, defines the two individual leading cutting/buffing edges 106a and 106b in a dove-tail configuration. The working end 105 of each of the tire rasp blade 100 protrudes away from the hub assembly, while it is arranged in the hub for cutting/buffing operations. Accordingly, depending on the direction of the rotation of the hub assembly (clockwise and anticlockwise), one of the leading cutting/buffing edges comes into contact with the surface of the tire. The cutouts as shown in FIG. 5 are exemplarily shown with a semi-circular configuration. It is within the purview of this invention to use other non-circular shapes such as triangular, square and other suitable shapes. The working end angle of the arcuate working end 105 is in the range of 60-90 degrees.

A first arc segment is arranged to extend from the terminal end 102a, where the first arc segment is defined by the cutouts or openings 1-19 having larger and smaller diameters to form the leading edges 106a. The cutouts 1-19 are arranged adjacent to each other to form a coarse pitch. A radius (r1) is formed between the centre point 107 and the working end (buffing leading edges of the first arc segment) 106a and this radius (r1) is substantially constant across the first arc segment, commencing from the terminal end 102a of the body 101.

Segment angle of the first arc segment is in the range of 10-45°, preferably 30-40°. Considering the exemplary angle of extent of the rasp blade as shown in FIG. 5, the most preferred segment angle of the first arc segment is about 45°. The first arc segment with such preferred segment angles having a coarse pitch facilitate the enhanced removal of carcass from the tire, prior to the texturing of the surface. A suitable buffing leading edge angle is also formed between top portion of the buffing leading edge and bottom portion of the bottom edge of the cutout of the larger diameter, as it performed for the rasp blade with three segments.

A second arc segment is arranged to follow the first arc segment, which is formed from the cutouts 20-37 having the cutouts with smaller and bigger diameters and with resultant buffing leading edges 106b. The cutouts 20-37 are arranged adjacent to each other with a desired fine pitch. In other words, the leading edges in second arc segment are arranged in a closer configuration as compared to the preceding first arc segment, so as to render a fine pitch to the buffing leading edges of this segment. Accordingly, whenever this second arc segment comes into contact with the tire during the course of buffing operations, the removal rate of the carcass of the tire is substantially reduced and the corresponding enhancement of fine surface texture is facilitated. The second arc segment is arranged to an angle in the range of 35-90°, preferably 60-70° and most preferably at about 45° as measured from the indicative base lines 104b to the base line 104c. This angular arrangement of the second arc segment with a fine pitch arrangement facilitates the texturing of the surface tyre, which is subjected to the coarse operations.

A suitable buffing leading edge angle is formed between top portion of the buffing leading edge and bottom edge of the cutout of the larger diameter of the second segment.

A radius (r2) is formed between the centre point 107 and the working end (leading edges) of the second arc segment as shown in FIG. 5 and this radius (r2) is constant across the second arc segment.

In yet another aspect of the present invention, the radius of the second arc segment is greater than the radius of the first arc segment. The variable radii of the first and segments is in the range of 0.10 to 0.50 mm.

### Advantages

The tire rasp blade of the present invention facilitates an enhanced rate of removal of carcass while maintaining the fine texture.

The functions of buffing leading edges (teeth) with coarse and fine pitches are performed by a single set of rasp blade sections arranged at 360 degrees.

The variable coarse and pitch segments of the working end of the rasp blade of the present invention facilitate reduction in heat generation during buffing operations.

The rasp blade of the present invention is with constant buffing leading edge height and variable pitch.

The foregoing description of the tire rasp blade of the present invention are illustrative and explanatory thereof, and various changes in the size and shape of hubs and configurations, and differing materials, as well as changes in the details of the illustrated embodiments may be made without departing from the spirit of the invention. All such modifications and changes are intended to be covered by the appended claims.

1. A tire rasp blade for a buffing machine comprising:
a planar body with terminal ends; and
at least three arc segments of buffing leading edges with coarse and fine pitches, said arc segments are with variable segment angles and arranged in between the terminal ends, to form an arcuate working end with a working end angle, and
the first arc segment is defined by a coarse pitch and is arranged at one terminal end followed by an arrangement of second and third arc segments that are defined by an incremental fine pitch.

2. The rasp blade as claimed in claim 1, wherein the pitch of the buffing leading edges of the first arc segment is in the range of 8-11 mm, the second arc segment in the range of 7-10 mm and third arc segment in the range of 6-9 mm.

3. The tire rasp blade as claimed in claim 1, wherein the segment angle of the first arc segment is in the range of 10-35 degrees, preferably 20-30, the segment angle of the second arc segment is the range of 20-40, preferably 30-40 degrees and the segment angle of the third arc segment is in the range of 10-35 degrees, preferably 20-30 degrees.

4. The rasp blade as claimed in claim 1, wherein the working end angle of the arcuate working end is in the range of 60-90 degrees.

5. The tire rasp blade as claimed in claim 1, wherein the first, second and third arc segments are disposed with a pitch angle in the range of 2-7°.

6. The tire rasp blade as claimed in claim 1, wherein the first, second and third arc segments are disposed with buffing leading edge angles in the range of 45-55°, 40-50° and 35-45°, respectively.

7. The rasp blade as claimed in claim 1, wherein the pitch and the buffing leading edge angles are constant within the arc segments.

8. The rasp blade as claimed in claim 1, wherein the sum of the buffing leading edge angles of the arc segments is equal to the working end angle.

9. The tire rasp blade as claimed in claim 1, wherein the radius of the third arc segment is greater than the radii of the first and second arc segments and the radius of the second arc segment is greater than the radius of the first arc segment.

10. The tire rasp blade as claimed in claim 9, wherein the variable radii of the first, second and third arc segments is the range of 0.25 to 0.50 mm.

11. The rasp blade as claimed in claim 1, wherein the buffing leading edges with fine and coarse pitches are arranged alternately between the terminal ends.

12. The tire rasp blade as claimed in claim 1, wherein at least two arc segments of buffing leading edges with coarse and fine pitch, having variable radii and segment angles are arranged in between the terminal ends.

13. The tire rasp blade as claimed in claim 12, wherein the radius of the second arc segment is greater than the radius of the first arc segment.

14. The tire rasp blade as claimed in claim 12, wherein the variable radii is in the range of 0.10 to 0.50 mm.

15. The tire rasp blade as claimed in claim 12, wherein the segment angle of the first arc segment is in the range of 10-45°, preferably 30-40° and the segment angle of the second arc segment is the range of 35-90°, preferably 60-70°.

16. The rasp blade as claimed in claim 2, wherein the pitch and the buffing leading edge angles are constant within the arc segments.

17. The rasp blade as claimed in claim 3, wherein the pitch and the buffing leading edge angles are constant within the arc segments.

18. The rasp blade as claimed in claim 4, wherein the pitch and the buffing leading edge angles are constant within the arc segments.

19. The rasp blade as claimed in claim 5, wherein the pitch and the buffing leading edge angles are constant within the arc segments.

20. The rasp blade as claimed in claim 6, wherein the pitch and the buffing leading edge angles are constant within the arc segments.
